(19) United States
(12) Patent Application Publication
(10) Pub. No.: US 2007/0130425 A1
(43) Pub. Date: Jun. 7, 2007

(54) Semiconductor memory card

(76) Inventor: Eiji Ueda, Toyota-gun (JP)

Correspondence Address: WENDEROTH, LIND & PONACK L.L.P., 2033 K. STREET, NW, SUITE 800, WASHINGTON, DC, 20006, US

(21) Appl. No.: 10/588,108

(22) PCT Filed: May 13, 2005
(86) PCT No.: PCT/JP05/09208

§ 371 Date: Jul. 31, 2006

(30) Foreign Application Priority Data
May 25, 2004 (JP) 2004-155188

(51) Int. Cl. G06F 12/00

(52) U.S. Cl. 711/115

(57) ABSTRACT

The present invention provides a semiconductor memory card with which a user can select processing for data that is stored in a readout destructive storage unit when the data is read out. An IC card (1300) includes: FeRAM (125) that stores a data which becomes uncertain in FeRAM (125) after the date is read out; a processing information storage unit (305) that stores processing mode determination information; a reading unit (301); a processing mode determination unit (303) that determines a mode of writing into a designated address of FeRAM (125), comparing the designated address with the information, when the data is read out by the reading unit (301); and a writing unit (302) that writes or does not write certain data into the designated address according to the mode determined after the data in the designated address is read out.

### TECHNICAL FIELD

The present invention relates to a semiconductor memory card that carries a memory having destructive readout characteristics.

### BACKGROUND ART

As integrated circuit (IC) technology and the like have been developed, a semiconductor memory card that carries a Central Processing Unit (CPU) and memories, so-called an IC card, has been utilized and attracted attention. The memories in the IC card are, for example, a Read Only Memory (ROM), a Random Access Memory (RAM), and the like.

In some memories in the IC card, when data stored in memory cells is read out, the stored data destroys itself. As such memories, for example, a Ferroelectric Random Access Memory (FeRAM) that stores data in a polarized state of a ferroelectric substance, a Dynamic Random Access Memory (DRAM), and the like have been known.

The FeRAM and the DRAM are characterized in that a time period from data writing start to data writing completion is short, in other words, it is possible to write data at a high speed, that their high integration enables a chip of the same dimension to be mounted with a larger capacity memory, that power consumption is low, and the like.

The FeRAM and the DRAM generally rewrite, immediately after data has been read out, the data into the memory in order to hold the same data. It can be said that this does not prevent the data from being destroyed, but restore the data by writing the same data immediately after the data has been destroyed.

Meanwhile, in recent years, in service business and the like, the IC card has been used for a variety of applications. When the IC card is used, there is a case that the user has only once read out data stored in the memory, and then wishes to delete the data. An example of such case is that, when the IC card communicates with a reader/writer and a host computer using encryption, the user, after using an encryption key only once, wishes to delete the encryption key for security. Another example is that the user wishes to delete a test parameter written during manufacturing the IC card.

However, the conventional IC card does not have a function to automatically delete the stored data. Therefore, it would be desirable to provide an IC card having a function to automatically delete data after reading out only once the data stored in a memory.

In order to achieve the above object, an IC card including a feedback selection unit is proposed. A readout signal including data which is read out from a readout destructive storage unit is inputted as a feedback signal into the feedback selection unit, and then, depending on a selection signal outputted from a control circuit, the feedback selection unit outputs or does not alternatively into the readout destructive storage unit, the feedback signal as a write signal including the data.

### DISCLOSURE OF INVENTION

For the above IC card, it is necessary to instruct, from the outside, the control circuit whether or not to perform the readout destruction. However, conventionally any practical implementation means of such a control circuit have not been suggested. Most of the IC card applications have been security-related ones. In some of the practical implementation means of control circuits, there is a risk that security could be attacked. If a tamper means manipulate the control circuits, it is conceivable that the data which needs to remain stored would be deleted, so that a tamper-resistant control circuit is required.

There is a case that, when data stored in the readout destructive storage unit of the IC card is read out, the user wishes to select processing for the data. An example of such case is that the user wishes to select processing for holding the data that has been read out, or processing for deleting such data.

The present invention has been conceived the above problem, and an object of the invention is to provide a semiconductor memory card with which it is possible for the user, when data stored in a readout destructive storage unit is read out, to select processing for the data.

In order to achieve the above object, a semiconductor memory card of the present invention is provided to include: a first storage unit operable to store data, the first storage unit having characteristics by which the data becomes uncertain in the first storage unit the after the data is read out; a second storage unit operable to store processing mode specification information that specifies a mode of writing into each address of the first storage unit after the stored data is read out; a reading unit operable to read out the data stored in a designated address of the first storage unit; a processing mode determination unit operable to determine a mode of writing into the designated address, comparing the designated address with the processing mode specification information, when the stored data is read out by the reading unit; and a writing unit operable alternatively to write or not to write certain data into the designated address according to the mode determined by the processing mode determination unit after the data stored in the designated address is read out.

The mode of writing is determined for each designated address, so that when the data stored in the first storage unit is read out, the user can select the processing for the data.

The writing unit may be operable to write the certain data that is a specific value into the designated address. Accordingly, it is possible to completely erase a trace of the data that has been read out.

The semiconductor memory card of the present invention may further includes a random number generation unit operable to generate a random number, wherein the writing unit is operable to write the certain data that is the random number generated by the random number generation unit into the designated address. Accordingly, it becomes difficult to guess the trace of the data that has been read out.

The writing unit may be operable to write the certain data that is read out by the reading unit into the designated address. Accordingly, the data that has been read out is held.

The designated address may be different from an address to be processed by the reading unit and the writing unit.

The specific part of the designated address may be used for determining the mode of writing.

The present invention can provide a semiconductor memory card with which it is possible for the user, when data stored in a readout destructive storage unit is read out, to select processing for the data.

According to the semiconductor memory card of the present invention, by designating the address, the user can change the mode of processing when data is read out. Accordingly, it is possible to prevent the data from being destroyed by an insecure access to the readout destructive storage unit. This means that security strength of the data stored in the semiconductor memory card of the present invention is strong.

Furthermore, the present invention can be implemented as a method including steps using characteristic elements of the semiconductor memory card of the present invention, as a program causing a computer to execute the steps, as a storage medium, such as a CD-ROM, storing the program, and as an integrated circuit. The program is able to be distributed via a transmission medium such as a communication network.

### FURTHER INFORMATION ABOUT TECHNICAL BACKGROUND TO THIS APPLICATION

The disclosure of Japanese Patent Application No. 2004-155188 filed on May, 25, 2004 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is an overview diagram showing an use environment of an IC card;

FIG. 2 is a diagram showing a hardware configuration of the IC card;

FIG. 3 is a diagram showing a software configuration of a part of the IC card according to a first embodiment;

FIG. 4 is a flowchart showing steps in processing when data is read out;

FIG. 5 is a flowchart showing steps in write processing for each readout address;

FIG. 6 is a diagram showing a table that specifies a mode of writing into each address where data that is read out has been previously stored, according to the first embodiment;

FIG. 7 is a diagram showing each area in FeRAM according to the first embodiment;

FIG. 8 is a diagram showing a software configuration of a part of an IC card according to a second embodiment;

FIG. 9 is a diagram showing a table that specifies a mode of writing into each address where data that is read out has previously been stored, according to the second embodiment;

FIG. 10 is a diagram showing each area in FeRAM according to the second embodiment;

FIG. 11 is a diagram showing that some functions in the IC card according to the first embodiment are implemented into a LSI; and

FIG. 12 is a diagram showing that some functions in the IC card according to the second embodiment are implemented into a LSI.

### BEST MODE FOR CARRYING OUT THE INVENTION

The following describes best modes for carrying out the present invention with reference to the drawings.

### First Embodiment

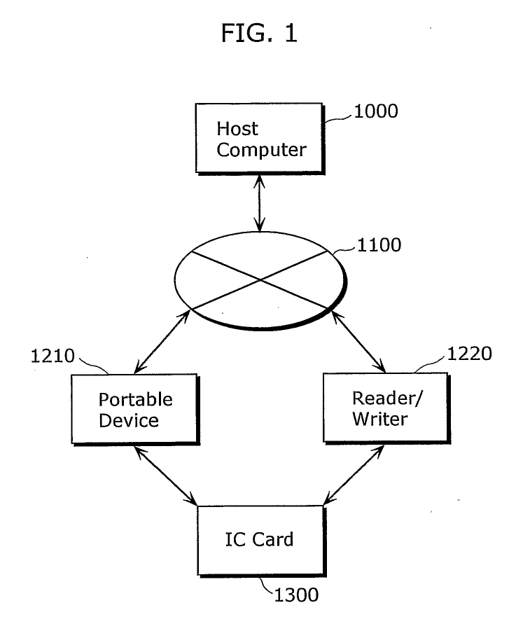

First of all, an example of usages of a semiconductor memory card, more specifically an IC card, according to the first embodiment is described. The IC card is used by a user with a portable device, such as a portable telephone, and a reader/writer which serve as interfaces to a host computer. FIG. 1 is an overview diagram showing a use environment of IC card 1300.

The operating environment in FIG. 1 includes: host computer 1000; communication network 1100; portable device 1210; reader/writer 1220; and IC card 1300.

Host computer 1000, using reader/writer 1220 or portable device 1210 as an interface, provides via communication network 1100 a variety of services to IC card 1300. The services are, for example, Electric Commerce (EC) services and the like.

Reader/writer 1220 is, for example, a cash dispenser of credit card companies or financial institutions, or a device installed in cash registers in shops. Reader/writer 1220 supplies IC card 1300 with electric power, and communicates with IC card 1300 wirelessly. Reader/writer 1220 is connected to communication network 1100. Via reader/writer 1220 and IC card 1300, the user can receive the services provided by host computer 1000.

Portable device 1210 is a device which is connected with IC card 1300 or in which IC card 1300 is inserted, and relays communication between IC card 1300 and host computer 1000. On portable device 1210, a user interface program such as browser software is mounted, and using the program, the user can receive the services provided by host computer 1000.

Next, a hardware configuration of IC card 1300 according to the first embodiment is described.

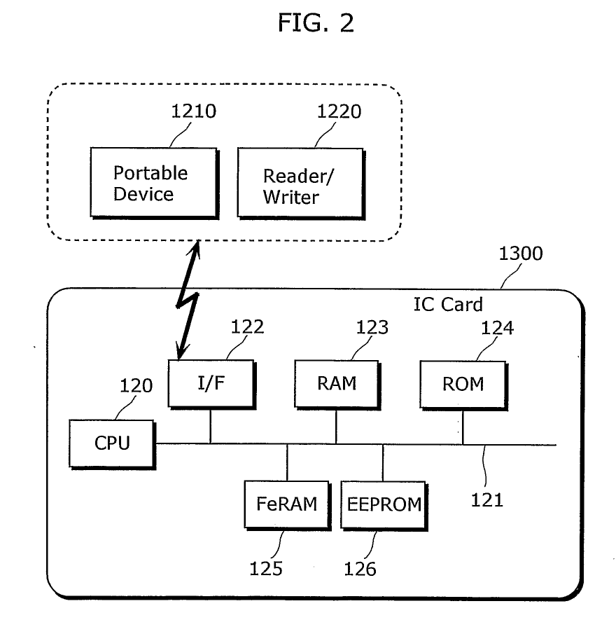

FIG. 2 is a diagram showing the hardware configuration of IC card 1300. IC card 1300 is one example of the semiconductor memory card according to the present invention. As shown in FIG. 2, IC card 1300 includes: CPU 120; I/F 122; RAM 123; ROM 124; FeRAM 125; EEPROM 126; and bus 121. CPU 120, I/F 122, RAM 123, ROM 124, FeRAM 125 and EEPROM 126 are connected to bus 121. IC card 1300 has the configuration shown in FIG. 2, and can be produced industrially.

EEPROM 126 is a non-volatile memory where data is read out and written in units of predetermined memory blocks. On the other hand, FeRAM 125 is a non-volatile memory where data is read out and written in units of bytes. A reading/writing speed in FeRAM 125 is high, compared with that in EEPROM 126. However, a price of FeRAM 125 is generally high, as compared to that of EEPROM 126 having the same storage capacity. Furthermore, FeRAM 125 has characteristics by which data becomes uncertain after being read out. Therefore, to hold the data in FeRAM 125, it is necessary to write the same data after the data has been read out. The first embodiment is characterized in processing when the data in FeRAM 125 is read out. FeRAM 125 and EEPROM may coexist. Both memories overcome the shortcomings of each other, and can be implemented together on a single IC card 1300.

ROM 124 is a read-only memory that stores programs for operating IC card 1300. The programs are, for example, an Operating System (OS), a JAVA™ virtual machine, an application program, and the like.

CPU 120 executes the variety of programs stored in ROM 124.

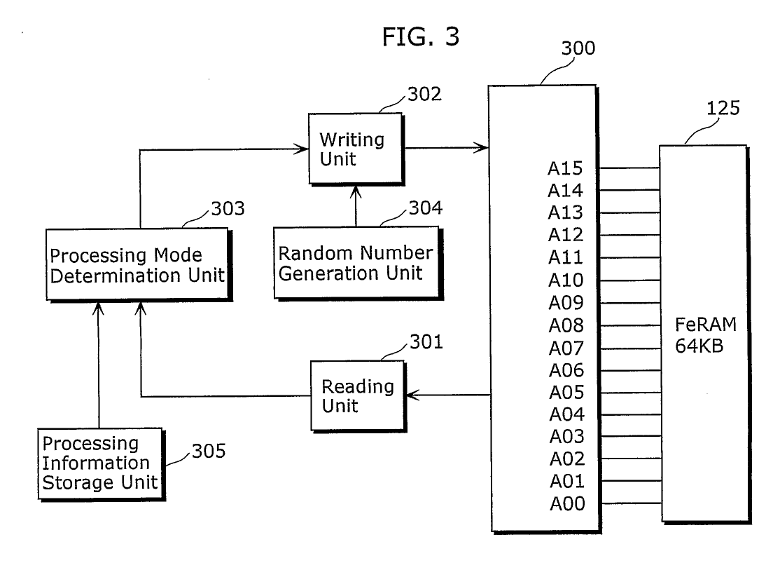

FIG. 3 is a diagram in which a part including ROM 124, CPU 120, and FeRAM 125 in IC card 1300 of FIG. 2 is converted into a software configuration.

Reading unit 301 reads out the data stored in FeRAM 125 having a capacity of 64 Kbytes, after a predetermined address is designated. The address is designated by address decoder 300. The data that has been read out is destroyed by the characteristics of FeRAM. It is impossible to predict, before data has been read out, changes in the data caused by the destruction. Therefore, to hold the data, writing unit 302 needs to rewrite the data that is read out, into the address where the data has been previously stored.

Here, in the first embodiment, when the data is read out, processing mode determination unit 303 compares a processing mode specification table that is stored in processing information storage unit 305 and the address where the readout data is stored, and determines, depending on the address, a mode of writing into the address. The processing mode specification table is a table that specifies a mode of writing into the address where the data that is read out has been previously stored.

That is, processing mode determination unit 303, depending on the address, determines one of processing for writing to be performed in the address where the data is read out has been previously stored, from the following processing (1) to (4): (1) for not writing any data; (2) for writing data that is the same as the data that is read out; (3) for writing specific data; or (4) for writing data based on a random number. The specific data is data that is assigned to all of the address with a specific value of “0” or “1”. The random number is generated by random number generation unit 304.

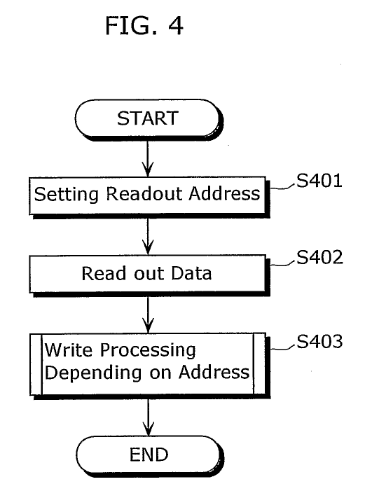

The above processing performed when the data in FeRAM 125 is read out is described with reference to a flowchart of FIG. 4.

Firstly, reading unit 301 gives address decoder 300 a readout address in order to read out data (S401). Address decoder 300 decodes the given address, and reading unit 301 reads out data that is stored in the decoded address in FeRAM 125 (S402). At this step, the data in FeRAM 125 that has been read out is destroyed.

When reading unit 301 reads out the data in FeRAM 125, processing mode determination unit 303 obtains a processing mode specification table stored in processing information storage unit 305 and the address where readout data is stored, compares them, and determines a mode of writing into the address. The determination of the mode of writing will be described in detail further below. By the mode determined by processing mode determination unit 303, writing unit 302 writes certain data into the address where the readout data has been previously stored, or does not alternatively (S403).

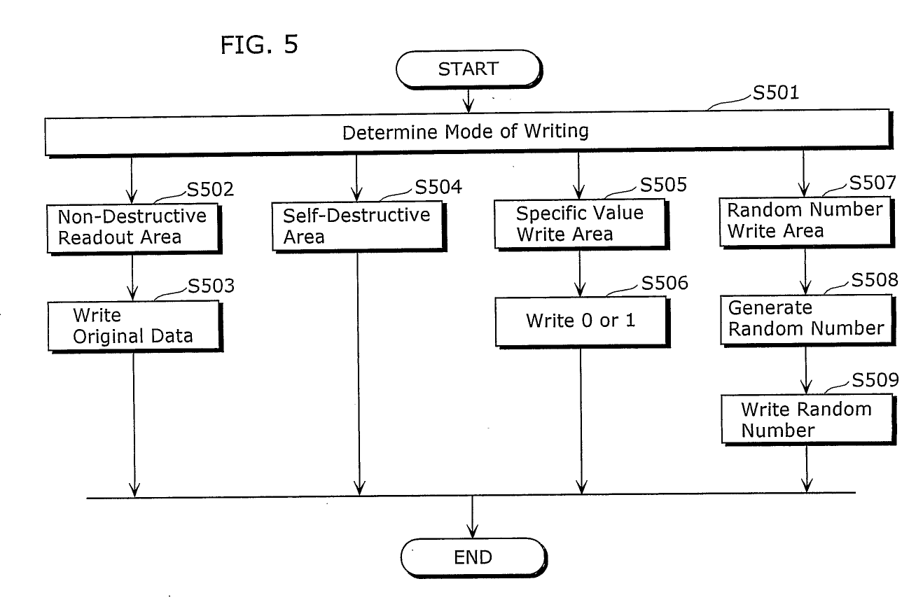

Next, referring to a flowchart of FIG. 5, a description is given in detail for how the processing for writing data is performed in the address where the data that is read out has been previously stored.

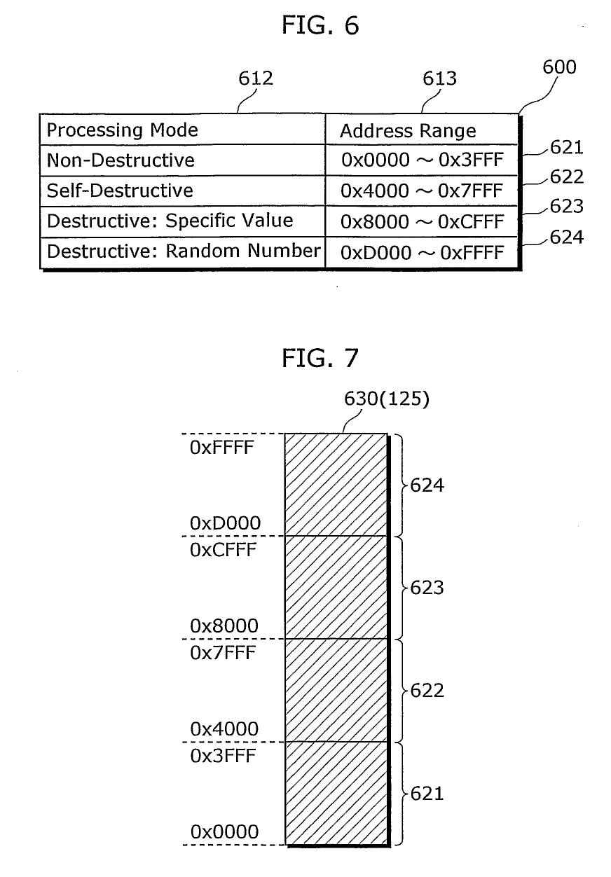

Processing mode determination unit 303 receives the address where the readout data is stored, then compares the address with processing mode specification table 600 stored in processing information storage unit 305, and determines a mode of writing depending on the address (S501). Referring to FIG. 6, processing mode specification table 600 is a table that specifies a mode of writing into the address where the data is read out has been previously stored.

Referring to a memory map 630 of FIG. 7, areas in FeRAM 125 are separated as: non-destructive readout area 621; self-destructive area 622; specific value write area 623; and random number write area 624.

(1) Non-destructive readout area 621 is an area where addresses range from “0×0000” to “0×3FFF”. (2) Self-destructive area 622 is an area where addresses range from “0×4000” to “0×7FFF”. (3) Specific value write area 623 is an area where addresses range from “0×8000” to “0×CFFF”. (4) Random number write area 624 is an area where addresses range from “0×D000” to “0×FFFF”. The above setting for the address areas is one example, and it is possible to set other address areas.

The following describes respective processing for writing in cases that an address of the data to be read out (a readout address) belongs to the above four address areas.

(1) When the readout address belongs to non-destructive readout area 621 (S502), the following processing is performed.

Writing unit 302 obtains the readout address and the data that is read out, and writes data that is the same as the data that has been read out into the readout address in FeRAM 125 (S503). That is, when the readout address belongs to non-destructive readout area 621, the readout processing is performed as non-destructive readout, and the data in the readout source is stored.

(2) When the readout address belongs to self-destructive area 622 (S504), the following processing is performed.

Writing unit 302 obtains the readout address and the data that is read out. However, writing unit 302 does not perform processing for writing into the readout address in FeRAM 125. That is, when the readout address belongs to self-destructive area 622, readout processing is performed as destructive readout, so that the data in the readout source is not stored and becomes an unpredictable value.

(3) When the readout address belongs to specific value write area 623 (S505), the following processing is performed.

Writing unit 302 obtains the readout address and the data that is read out. However, writing unit 302 does not write the data that has been read out into the readout address in FeRAM 125, but writes a specific value that is “1” or “0” (S506).

That is, when the readout address belongs to specific value write area 623, readout processing is performed as destructive readout, and the specific value is written into the readout address.

(4) When the readout address belongs to random number write area 624 (S507), the following processing is performed.

Writing unit 302 obtains the readout address and the data that is read out. However, writing unit 302 does not write the data that has been read out into the readout address in FeRAM 125. Random number generation unit 304 generates a random number (S508). Writing unit 302 writes a value based on the random number generated by random number generation unit 304 into the readout address in FeRAM 125 (S509).

That is, when the readout address belongs to random number write area 624, data readout is performed as destructive readout.

The following describes differences in the write processing between when the readout address belongs to random number write area 624 and when the readout address belongs to self-destructive area 622.

When the readout address belongs to random number write area 624, the data based on the random number generated by random number generation unit 304 is written into the address. Therefore, compared with a case using the readout destruction characteristics (self-destruction) specific to FeRAM 125, it becomes more difficult to predict data to be stored in the readout address. In the case using the readout destruction characteristics specific to FeRAM 125, it is impossible to predict data after being destroyed, but there is a possibility that deviation of value distribution in the memory would be caused by electrical characteristics. On the other hand, when the value generated by the random number is written, it is possible to reduce the deviation of the value in the memory.

### Second Embodiment

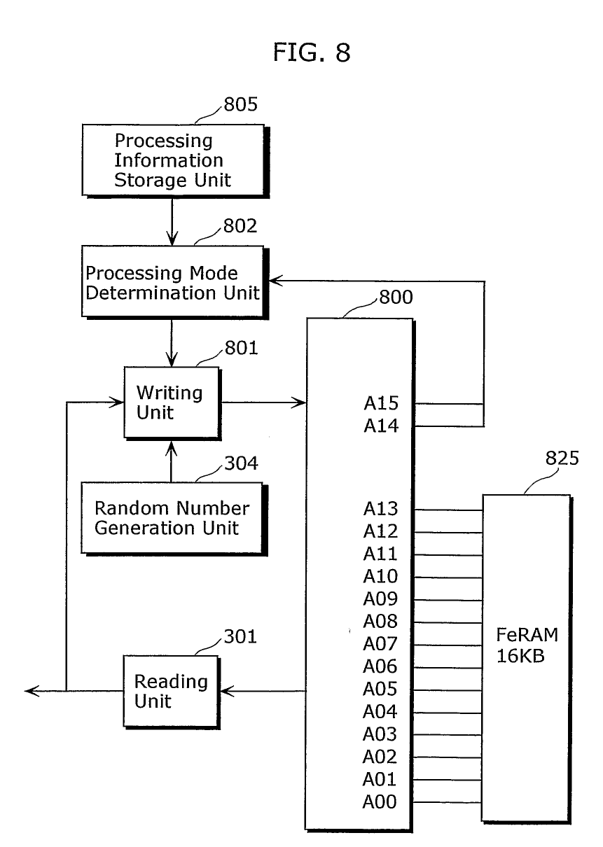

FIG. 8 is a diagram in which a part including ROM 124, CPU 120, and FeRAM 125 in IC card 1300 of FIG. 2 is converted into a software configuration.

The following describes the configuration that is different from the configuration according to the first embodiment.

FeRAM 825 is mounted with only a memory having a capacity of 16 Kbytes. Address decoder 800 decodes a part of the 16-bit address except its higher 2 bits. In other words, in the second embodiment, processing is not performed for a real memory corresponding to addresses including the above higher 2 bits. The above higher 2 bits, which are “A15” and “A14”, are used for determining the mode of writing.

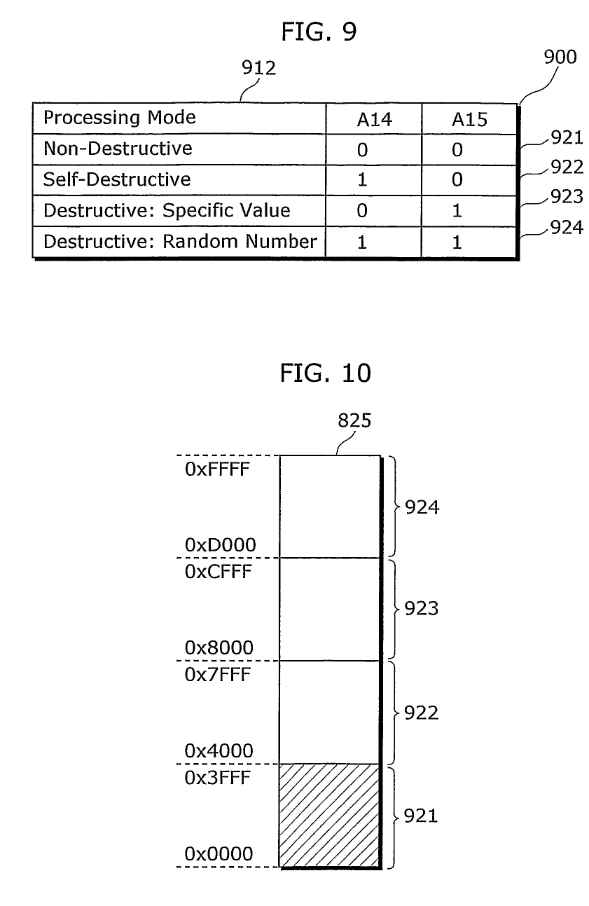

Processing mode determination unit 802 obtains the above higher 2 bits, which are values of “A15” and “A14”, and referring to processing mode specification table 900 shown in FIG. 9, determines the mode of writing depending on a combination of the obtained values. Processing mode determination unit 802 notifies writing unit 801 of the determined mode. Processing mode specification table 900 is stored in processing information storage unit 805.

The following describes processing for writing that is varied depending on the combination of the higher 2 bits of the readout address which are a value of “A15” and a value of “A14”.

(1) When the value of “A14” is “0” and the value of “A15” is “0”, as shown in FIG. 9, a mode of reading out is performed as non-destructive readout (921). That is, the mode of reading out is performed as non-destructive readout for an area where addresses range from “0×0000” to “0×3FFF”. In this case, processing for writing that is the same as the processing at above S502 and S503 is performed. The above steps have already been described in the first embodiment. Note that the above readout processing is performed as readout processing for a virtual address. That is, the higher 2 bits are not decoded in order to specify the address to be processed. As shown in a hatched part in FIG. 10, a range of the addresses to be processed is where real addresses range from “0×0000” to “0×3FFF”.

(2) When the value of “A14” is “1” and the value of “A15” is “0”, as shown in FIG. 9, a mode of reading out is performed as destructive readout (922). That is, the mode of reading out is performed as destructive readout for an area where addresses range from “0×4000” to “0×7FFF”. In this case, processing for writing that is the same as the processing at above S504 is performed. The above step has already been described in the first embodiment. Note that the above readout processing is performed as readout processing for a virtual address. That is, the higher 2 bits are not decoded in order to specify the address to be processed. As shown in the hatched part in FIG. 10, a range of the addresses to be processed is where real addresses range from “0×0000” to “0×3FFF”.

(3) When the value of “A14” is “0” and the value of “A15” is “1”, as shown in FIG. 9, a mode of reading out is performed as destructive readout, and a specific value is written (923). That is, the mode of reading out is performed as destructive readout, and a specific value is written into an area where addresses range from “0×8000” to “0×CFFF”. In this case, processing for writing that is the same as the processing at above S505 and S506 is performed. The above steps have already been described in the first embodiment. Note that the above readout processing is performed as readout processing for a virtual address. That is, the higher 2 bits are not decoded in order to specify the address to be processed. As shown in the hatched part in FIG. 10, a range of the addresses to be processed is where real addresses range from “0×0000” to “0×3FFF”.

(4) When the value of “A14” is “1” and the value of “A15” is “1”, as shown in FIG. 9, a mode of reading out is performed as destructive readout, and a random number is written (924). That is, the mode of reading out is performed as destructive readout, and a random number is written into an area where addresses range from “0×D000” to “0×FFFF”. In this case, processing for writing that is the same as the processing at above S507 to S509 is performed. The above steps have already been described in the first embodiment. Note that the above readout processing is performed as readout processing for a virtual address. That is, the higher 2 bits are not decoded in order to specify the address to be processed. As shown in the hatched part in FIG. 10, a range of the addresses to be processed is where real addresses range from “0×0000” to “0×3FFF”.

As described above, by designating the address of FeRAM 125, the user can change the mode of writing into the address where the data that is read out has previously been stored. Accordingly, it is possible to prevent the data from being destroyed by an insecure access to the destructive memory.

Further, the writing unit writes a specific value into a predetermined address after data has been read out. Accordingly, a trace of the data that has been read out can be completely erased.

Furthermore, the writing unit writes a value based on a random number into a predetermined address after data has been read out. Accordingly, it becomes difficult to guess the trace of the data that has been read out.

Note that the writing unit can complete the processing for writing faster in writing the specific value than in writing the value based on the random number.

### First Supplement to Embodiments

The first and second embodiments have been described as above. Note that respective functions of reading unit 301, writing unit 302, processing mode determination unit 303, and random number generation unit 304 which are included in IC card 1300, are implemented when CPU executes a computer program. The program may be stored in ROM inside IC card 1300, or may be downloaded from the outside and then stored in the non-volatile memories in IC card 1300.

### Second Supplement to Embodiments

Reading unit 301, writing unit 302, processing mode determination unit 303, and random number generation unit 304 may be implemented as a LSI that is an integrated circuit in combination with hardware resources such as CPU, RAM, ROM, and non-volatile memories. Reading unit 301, writing unit 302, processing mode determination unit 303, and random number generation unit 304 may be integrated separately, or a part or all of them may be integrated into a single chip.

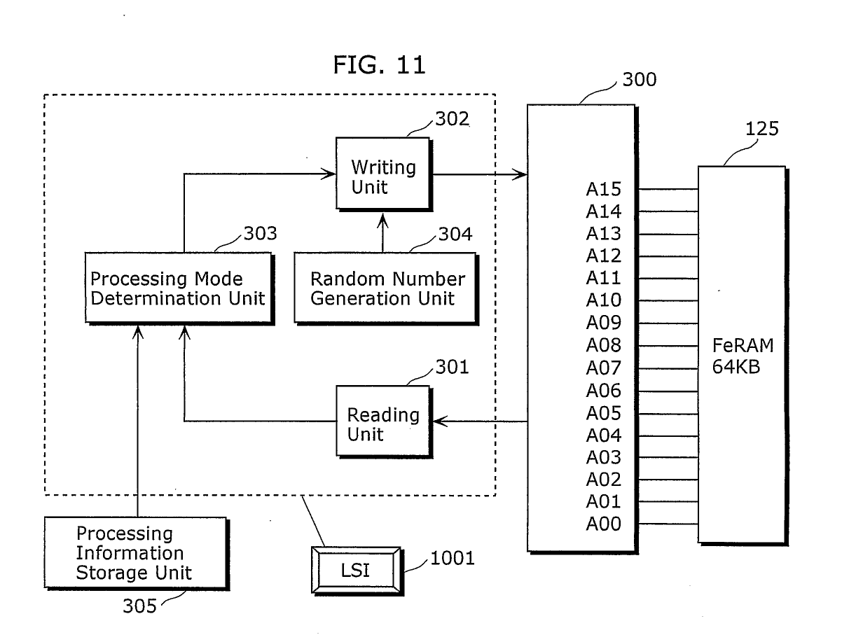

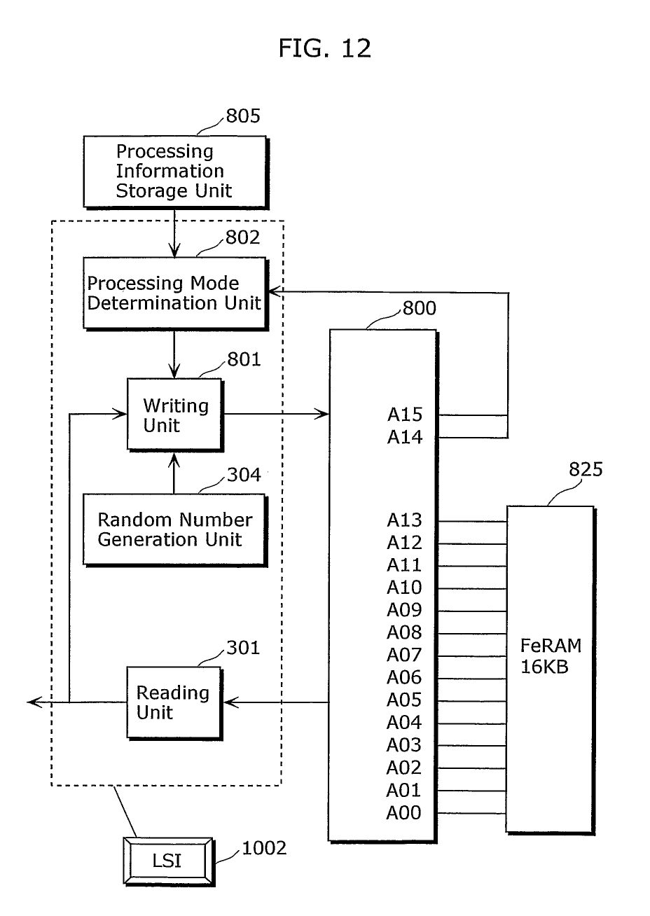

FIG. 11 shows one example of circuit integration of IC card 1300 according to the first embodiment. FIG. 12 shows one example of circuit integration of IC card 1300 according to the second embodiment. LSIs 1001 and 1002 are examples of the circuit integration. Each range enclosed with a dotted line in FIGS. 11 and 12 represents the example in which functional blocks are implemented into an integrated circuit. The integrated circuit can be called an IC, a system LSI, a super LSI or an ultra LSI depending on their degrees of integration.

The integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Furthermore, if due to the progress of semiconductor technologies or their derivations, new technologies for integrated circuits appear to be replaced with the LSIs, it is, of course, possible to use such technologies to implement the enclosed functional blocks as an integrated circuit. For example, biotechnology, organic chemical technology, and the like can be applied to the above implementation.

### INDUSTRIAL APPLICABILITY

The present invention is useful as an IC card or the like that carries a memory having destructive readout characteristics. The present invention can be applied to use of a RF tag or the like.

1. A semiconductor memory card comprising:
a first storage unit operable to store data, the first storage unit having characteristics by which the data becomes uncertain in the first storage unit the after the data is read out;
a second storage unit operable to store processing mode specification information that specifies a mode of writing into each address of the first storage unit after the stored data is read out;
a reading unit operable to read out the data stored in a designated address of the first storage unit;
a processing mode determination unit operable to determine a mode of writing into the designated address, comparing the designated address with the processing mode specification information, when the stored data is read out by the reading unit; and
a writing unit operable alternatively to write or not to write certain data into the designated address according to the mode determined by the processing mode determination unit after the data stored in the designated address is read out.

2. A semiconductor memory card according to claim 1,
wherein the writing unit is operable to write the certain data that is a specific value into the designated address.

3. A semiconductor memory card according to claim 1, further comprising a random number generation unit operable to generate a random number,
wherein the writing unit is operable to write the certain data that is the random number generated by the random number generation unit into the designated address.

4. A semiconductor memory card according to claim 1,
wherein the writing unit is operable to write the certain data that is read out by the reading unit into the designated address.

5. A semiconductor memory card according to claim 1,
wherein the designated address is different from an address to be processed by the reading unit and the writing unit.

6. A semiconductor memory card according to claim 1,
wherein a specific part of the designated address is used for determining the mode of writing.

7. A method for processing a storage unit after data is read out, in a semiconductor memory card including the storage unit operable to store the data, the storage unit having characteristics by which the data becomes uncertain in the storage unit after the data is read out, the method comprising:
reading out the data stored in a designated address of the storage unit;
determining a mode of writing into the designated address, comparing the designated address with processing mode specification information that specifies the mode of writing into each address of the storage unit after the stored data is read out, when the stored data is read out in the reading out; and
alternatively writing or not writing certain data into the designated address according to the mode determined in the determining of the mode of writing after the data stored in the designated address is read out.

8. An integrated circuit in a semiconductor memory card including a storage unit operable to store data, the storage unit having characteristics by which the data becomes uncertain in the storage unit after the data is read out, the integrated circuit comprising:
a reading unit operable to read out the data stored in a designated address of the storage unit;
a processing mode determination unit operable to determine a mode of writing into the designated address, comparing the designated address with processing mode specification information that specifies the mode of writing into each address of the storage unit after the stored data is read out, when the stored data is read out by the reading unit; and
a writing unit operable alternatively to write or not to write certain data into the designated address according to the mode determined by the processing mode determination unit after the data stored in the designated address is read out.

9. A program for processing a storage unit after data is read out, in a semiconductor memory card including the storage unit operable to store the data, the storage unit having characteristics by which the data becomes uncertain in the storage unit after the data is read out, the program causing a computer to execute:
reading out the data stored in a designated address of the storage unit;
determining a mode of writing into the designated address, comparing the designated address with processing mode specification information that specifies the mode of writing into each address of the storage unit after the stored data is read out, when the stored data is read out in the reading out; and
alternatively writing or not writing certain data into the designated address according to the mode determined in the determining of the mode of writing after the data stored in the designated address is read out.

10. A storage medium that stores a program for processing a storage unit after data is read out, in a semiconductor memory card including the storage unit operable to store the data, the storage unit having characteristics by which the data becomes uncertain in the storage unit after the data is read out, the program causing a computer to execute:
reading out the data stored in a designated address of the storage unit;
determining a mode of writing into the designated address, comparing the designated address with processing mode specification information that specifies the mode of writing into each address of the storage unit after the stored data is read out, when the stored data is read out in the reading out; and
alternatively writing or not writing certain data into the designated address according to the mode determined in the determining of the mode of writing after the data stored in the designated address is read out.
